(19) United States
(12) Patent Application Publication
(10) Pub. No.: US 2009/0063333 A1
(43) Pub. Date: Mar. 5, 2009

(54) Apparatus And Method For Payment Card Account Personalization

(75) Inventors: Anant Nambiar, Larchmont, NY (US); Marc Del Bene, Darien, CT (US); Jared H. Levin, Danbury, CT (US); Geetha Panchapakesan, Scarsdale, NY (US)

Correspondence Address: RYAN, MASON & LEWIS, LLP, 1300 POST ROAD, SUITE 205, FAIRFIELD, CT, 06824, US

(73) Assignee: MasterCard International Incorporated, Purchase, NY (US)

(21) Appl. No.: 11/848,285

(22) Filed: Aug. 31, 2007

(51) Int. Cl. G06Q 40/00

(52) U.S. Cl. 705/39; 235/380; 705/35

(57) ABSTRACT

Techniques for payment card account personalization include obtaining access to data describing a first set of parameters associated with the payment card account and obtaining indications of a first change in a life situation of an account holder. The first change may be one that has occurred since establishment of the first set of parameters. Presentation of a first menu of updated parameter choices to the holder is facilitated. The presentation of the first menu can be based upon the first change in the life situation of the holder. A holder selection can be obtained from the first menu, including data describing a second set of parameters associated with the payment card account, the second set of parameters being different than the first set of parameters. The payment card account then operates according to the second set of parameters. In some instances, account parameters can be updated across multiple financial institutions, by a service provider.

### FIELD OF THE INVENTION

The present invention relates generally to electronic commerce, and, more particularly, to payment cards and the like.

### BACKGROUND OF THE INVENTION

Today's consumers can choose from hundreds of credit card offers with different interest rates, fees, reward programs and other features and benefits. By investing some time in research, consumers can sift through the options and apply for the cards that best suit their current needs. Once consumers have obtained their preferred credit cards, however, there is no way for consumers to modify them. The features, benefits, rewards program and, frequently, the fees and interest rates are all fixed. Should a consumer decide that his or her card features and benefits are no longer relevant, he or she has no choice but to cancel the card, research other credit card options, and go through the application process all over again.

The growing number of people who use their cards to set up recurring billing must also contact each service provider with whom they have set up recurring billing and provide the new credit card information. Those consumers who have their bank pay off their credit card balance automatically each month must also inform their bank of the change.

People's lives are constantly evolving, affecting what credit card features and benefits suit them best. A college student may want a card that provides discounts at book stores, allows the student to set spending limits or to receive alerts when spending thresholds have been reached, and that guarantees preferred access to sporting events. A few year's later, once this same person has joined the workforce, he or she may want a very different set of card features and benefits. Perhaps he or she travels for work and needs travel-related benefits such as lost luggage protection, rental car insurance coverage and discounts at hotel chains. Should he or she proceed to have a family, this same person may again need new card features and benefits. Perhaps a card that helps him or her save money for a child's education (for example, by placing 1% of spending into a college fund), or that provides discounts at home improvement stores, may be desirable. Older families and retirees are likely to have a whole different set of preferences around the features and benefits of their credit cards.

Credit card (and other payment card) needs change as people progress through life—not only as they age and move into different life stages, but also as their life circumstances change. Any number of life events such as moving one's home, receiving a promotion or starting a small business can affect the type of features and benefits someone may want his or her credit card to offer.

Some issuing banks will allow qualified consumers to negotiate better pricing and interest rates. Typically, these concessions are made only after the consumer threatens to cancel his or her card, and may require haggling with a customer service representative. Other issuing banks may allow consumers to request additional changes to their credit card These requests, however, may be accepted or denied The process is ad hoc and can be time consuming for both the consumer and the issuing bank. Consumers typically do not know what they can or cannot request and proceed by trial and error, making requests and waiting to see how their financial institution responds.

JP Morgan Chase recently introduced the CHASE FREEDOM product which allows consumers to choose whether to receive rewards as cash back or as points that can be redeemed for goods and services. The program, however, is limited to this one feature. The Bank of Montreal (BMO) created a service associated with its MOSAIK CARD program that allows consumers to modify their credit cards by selecting from a limited number of card features and benefits. The BMO MOSAIK CARD program allows selections to be made via a customer-facing interface that connects with the bank's internal systems. All processing is contained within the bank and therefore available only to bank customers. In addition, the options that consumers can select from are static and are not customized to fit individual consumers.

### SUMMARY OF THE INVENTION

Principles of the present invention provide techniques for payment card account personalization. An exemplary embodiment of a method (which can be computer-implemented), according to one aspect of the invention, for updating parameters of a payment card account in response to life changes of a holder of the payment card account, includes the steps of obtaining access to data describing a first set of parameters associated with the payment card account, and obtaining indications of a first change in a life situation of the holder. The first change may be one that has occurred since establishment of the first set of parameters. The method can further include the step of facilitating presentation of a first menu of updated parameter choices to the holder. The presentation of the first menu can be based upon the first change in the life situation of the holder. The method can still further include the step of obtaining a holder selection from the first menu. The holder selection from the first menu can include data describing a second set of parameters associated with the payment card account, the second set of parameters being different than the first set of parameters. The method can still further include facilitating updating the payment card account to operate according to the second set of parameters.

In some instances, the holder is a first holder and the payment card account is a first payment card account, and an additional step is performed of repeating the above-mentioned steps for a second holder of a second payment card account. In this case, in the repeated step of facilitating presentation of the first menu, the first menu presented to the first holder and the first menu presented to the second holder are different from each other based on different characteristics of the first holder and the second holder.

In another aspect, an exemplary embodiment of a method (which can be computer-implemented) for updating parameters of payment card accounts across financial institutions includes the step of obtaining access to (i) data describing a first set of parameters associated with a first one of the payment card accounts, of a first holder, at a first one of the financial institutions, and (ii) data describing a second set of parameters associated with a second one of the payment card accounts, of a second holder, at a second one of the financial institutions. The method further includes facilitating presentation of a first menu of parameter update choices to the first holder and a second menu of parameter update choices to the second holder, and obtaining a first holder selection from the first menu and a second holder selection from the second menu. The first holder selection from the first menu includes data describing a third set of parameters associated with the first payment card account, the third set of parameters being different than the first set of parameters, and the second holder selection from the second menu includes data describing a fourth set of parameters associated with the second payment card account, the fourth set of parameters being different than the second set of parameters. The method still hither includes facilitating updating the first and second payment card accounts to operate according to the third and fourth sets of parameters, respectively. The steps can be performed by a service provider.

In still another aspect, the parameters need not necessarily be updated based upon a life event of a holder of the payment card, but the holder is presented with a customized menu. Thus, in this aspect, a method of updating parameters of a payment card account having a holder includes the steps of obtaining access to data describing a first set of parameters associated with the payment card account, and facilitating presentation of a first menu of updated parameter choices to the holder, the first menu being customized for the holder. The method further includes obtaining a holder selection from the first menu, the holder selection from the first menu including data describing a second set of parameters associated with the payment card account, the second set of parameters being different than the first set of parameters, and facilitating updating the payment card account to operate according to the second set of parameters.

One or more embodiments of the invention or elements thereof can be implemented in the form of a computer product including a computer usable medium with computer usable program code for performing, and/or facilitating performance of, the method steps indicated Furthermore, one or more embodiments of the invention or elements thereof can be implemented in the form of an apparatus including a memory and at least one processor that is coupled to the memory and operative to perform, and/or facilitate performance of, exemplary method steps. In still another aspect, an apparatus or system can comprise means for performing, and/or facilitating performance of the various method steps. The means can include one or more hardware modules, one or more software modules, or a mixture of one or more software modules and one or more hardware modules. As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed.

One or more embodiments of the invention can provide one or more benefits, for example, giving consumers the option to update their cards to fit their changing needs, without the time and inconvenience involved in canceling and re-applying for another credit card. That is, consumers may retain the same card account number, yet change the underlying parameters, such as interest rate, annual fee, rewards, benefits, and so on; this in turn allows banks to keep good customers when such customers' needs change In one or more embodiments, consumers will also be provided a set of card feature and benefit options to choose from that are particularly relevant to them. This can be accomplished, for example, because such options may be based on their own past spending behaviors and/or recent life events. For instance, consumers about to have a child may be presented with some options that they had never even considered before and wouldn't have otherwise thought of—since a service provider, such as an operator of a payment card network, employing inventive techniques can see how thousands of other people who have had babies change their spending behavior, needs and/or preferences of expecting parents and others about to experience life changing events can be anticipated; this information can then be used to offer compelling card features and benefits to choose from. Furthermore, non-limiting examples of substantial beneficial technical effects afforded by one or more inventive embodiments include coding efficiency, since in one or more embodiments, each issuing bank that wants to offer inventive capability will not have to build their own proprietary solution (consumer interface and back end); such issuing banks can leverage one or more embodiments of this invention

These and other features and advantages of the present invention will become apparent from the following detailed description of illustrative embodiments thereof, which is to be read in connection with the accompanying drawings

### BRIEF DESCRIPTION OF THE DRAWINGS

FIG. 1 shows an example of a payment card system within which techniques of the present invention can be implemented;

FIG. 2 is a flow chart illustrating exemplary method steps, according to an aspect of the invention;

FIG. 3 is a system block diagram of an exemplary inventive system, according to another aspect of the invention;

FIGS. 4-8 depict exemplary interfaces that may be offered to one or mole consumers to update payment card account parameters, in accordance with one or more inventive techniques; and

FIG. 9 is a block diagram of an exemplary computer system useful in one or more embodiments of the present invention.

### DETAILED DESCRIPTION OF PREFERRED EMBODIMENTS

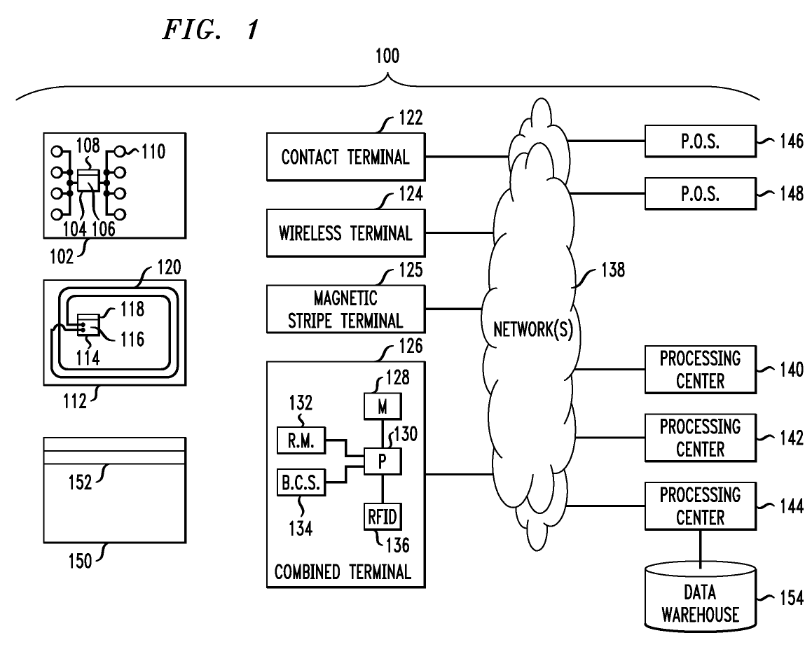

Attention should now be given to FIG. 1, which depicts an exemplary embodiment of a system 100, according to an aspect of the present invention, and including various possible components of the system. System 100 can include one or more different types of portable payment devices. For example, one such device can be a contact device such as card 102. Card 102 can include an integrated circuit (IC) chip 104 having a processor portion 106 and a memory portion 108. A plurality of electrical contacts 110 can be provided for communication purposes. In addition to or instead of card 102, system 100 can also be designed to work with a contactless device such as card 112. Card 112 can include an IC chip 114 having a processor portion 116 and a memory portion 118. An antenna 120 can be provided for contactless communication, such as, for example, using radio frequency (RF) electromagnetic waves. An oscillator or oscillators, and/or additional appropriate circuitry for one or more of modulation, demodulation, downconversion, and the like can be provided. Note that cards 102, 112 are exemplary of a variety of devices that can be employed with techniques of the present invention. Other types of devices could include a conventional card 150 having a magnetic stripe 152, an appropriately configured cellular telephone handset, and the like. Indeed, techniques of the present invention can be adapted to a variety of different types of cards, terminals, and other devices; even to “virtual” card accounts embodied as a data entry without a physical card or device.

The ICs 104, 114 can contain processing units 106, 116 and memory units 108, 118. Preferably, the ICs 104, 114 can also include one or more of control logic, a timer, and input/output ports. Such elements are well known in the IC art and axe not separately illustrated. One or both of the ICs 104, 114 can also include a co-processor, again, well-known and not separately illustrated. The control logic can provide, in conjunction with processing units 106, 116, the control necessary to handle communications between memory unit 108, 118 and the input/output ports. The timer can provide a timing reference signal from processing units 106, 116 and the control logic. The co-processor could provide the ability to perform complex computations in real time, such as those required by cryptographic algorithms.

The memory portions or units 108, 118 may include different types of memory, such as volatile and non-volatile memory and read-only and programmable memory. The memory units can store transaction card data such as, e.g., a user's primary account number (“PAN”) and/or personal identification number (“PIN”) The memory portions or units 108, 118 can store the operating system of the cards 102, 112. The operating system loads and executes applications and provides file management or other basic card services to the applications. One operating system that can be used to implement the present invention is the MULTOS® operating system licensed by StepNexus Inc, with information available at http://www.multos.com/. Alternatively, JAVA CARD™-based operating systems, based on JAVA CARD™ technology (licensed by Sun Microsystems, Inc., 4150 Network Circle, Santa Clara, Calif. 95054 USA), or proprietary operating systems available from a number of vendors, could be employed. Preferably, the operating system is stored in read-only memory (“ROM”) within memory portion 108, 118. In an alternate embodiment, flash memory or other non-volatile and/or volatile types of memory may also be used in the memory units 108, 118.

In addition to the basic services provided by the operating system, memory portions 108, 118 may also include one or more applications. At present, one possible standard to which such applications may conform is the EMV payment standard set forth by EMVCo, LLC (http://www.emvco.com). It will be appreciated that, strictly speaking, the EMV standard defines the behavior of a terminal; however, the card can be configured to conform to such EMV-compliant terminal behavior and in this sense is itself EMV-compliant. It will also be appreciated that applications in accordance with the present invention can be configured in a variety of different ways.

As noted, cards 102, 112 are examples of a variety of payment devices that can be employed with techniques of the present invention. The primary function of the payment devices may not be payment, for example, they may be cellular phone handsets that implement techniques of the present invention. Such devices could include cards having a conventional form factor, smaller or larger cards, cards of different shape, key fobs, personal digital assistants (PDAs), appropriately configured cell phone handsets, or indeed any device with the capabilities to implement techniques of the present invention. The cards, or other payment devices, can include body portions (e.g., laminated plastic layers of a payment card, case or cabinet of a PDA, chip packaging, and the like), memories 108, 118 associated with the body portions, and processors 106, 116 associated with the body portions and coupled to the memories. The memories 108, 118 can contain appropriate applications. The processors 106, 116 can be operative to execute appropriate functionality. The applications can be, for example, application identifiers (AIDs) linked to software code in the form of firmware plus data in a card memory such as an electrically erasable programmable read-only memory (EEPROM). Again, note that “smart” cards are not necessarily required and a conventional magnetic stripe card can be employed.

A number of different types of terminals can be employed with system 100. Such terminals can include a contact terminal 122 configured to interface with contact-type device 102, a wireless terminal 124 configured to interface with wireless device 112, a magnetic stripe terminal 125 configured to interface with a magnetic stripe device 150, or a combined terminal 126. Combined terminal 126 is designed to interface with any type of device 102, 112, 150. Some terminals can be contact terminals with plug-in contactless readers. Combined terminal 126 can include a memory 128, a processor portion 130, a reader module 132, and optionally an item interface module such as a bar code scanner 134 and/or a radio frequency identification (REID) tag leader 136. Items 128, 132, 134, 136 can be coupled to the processor 130. Note that the principles of construction of terminal 126 are applicable to other types of terminals and are described in detail for illustrative purposes. Reader module 132 can be configured for contact communication with card or device 102, contactless communication with card or device 112, reading of magnetic stripe 152, or a combination of any two or more of the foregoing (different types of readers can be provided to interact with different types of cards e.g., contacted, magnetic stripe, or contactless). Terminals 122, 124, 125, 126 can be connected to one or more processing centers 140, 142, 144 via a computer network 138. Network 138 could include, for example, the Internet, or a proprietary network. More than one network could be employed to connect different elements of the system. Processing centers 140, 142, 144 can include, fox example, a host computer of an issuer of a payment device.

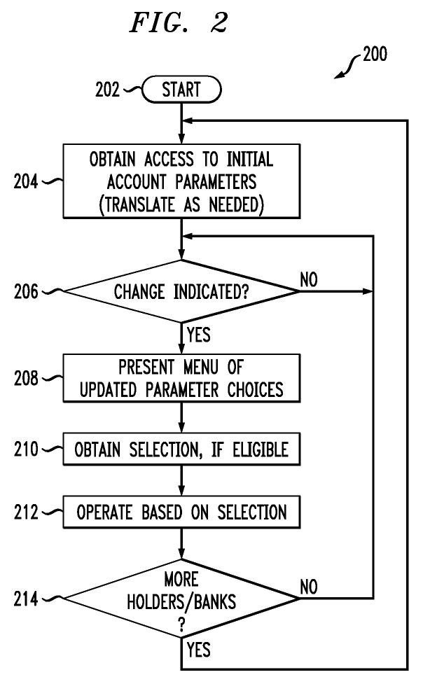

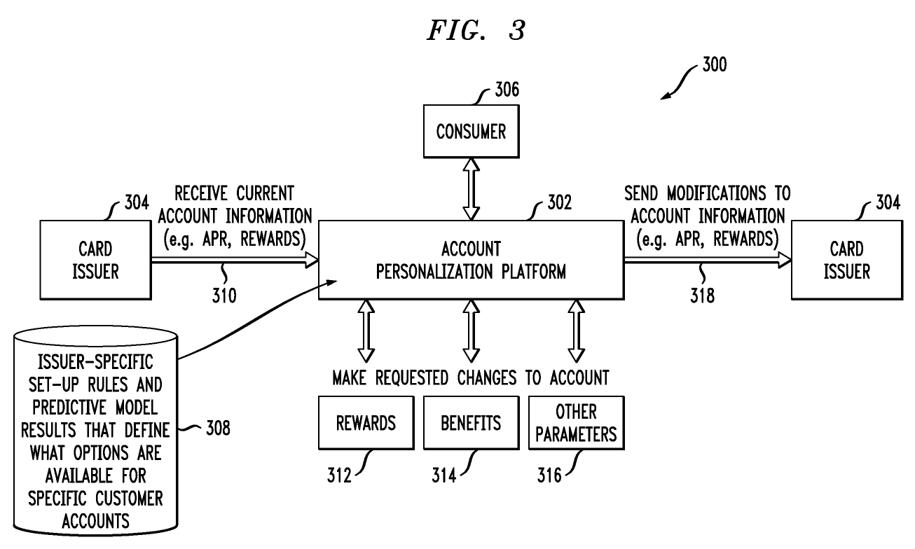

Many different retail or other establishments, represented by points-of-sale 146, 148, can be connected to network 138. Each such establishment can have one or more terminals. Further, different types of portable payment devices, terminals, or other elements or components can combine or “mix and match” one or more features depicted on the exemplary devices in FIG. 1. In one or more embodiments of the invention, network 138 can be formed, at least in part, by a payment card network such the BANKNET® network (registered mark of MasterCard International Incorporated, Purchase, N.Y., USA) or other similar network, and such network can include processing functionality as described with respect to FIGS. 2 and 3 below (for example, the account personalization platform functionality in FIG. 3).

Portable payment devices can facilitate transactions by a user with a terminal, such as 122, 124, 125, 126, of a system such as system 100. Such a device can include a processor, for example, the processing units 106, 116 discussed above. The device can also include a memory, such as memory portions 108, 118 discussed above, that is coupled to the processor. Further, the device can include a communications module that is coupled to the processor and configured to interface with a terminal such as one of the terminals 122, 124, 125, 126. The communications module can include, for example, the contacts 110 or antennas 120 together with appropriate circuitry (such as the aforementioned oscillator or oscillators and related circuitry) that permits interfacing with the terminals via contact or wireless communication. The processor of the apparatus can be operable to perform appropriate functionality. The processor can perform such operations via hardware techniques, and/or under the influence of program instructions, such as an application, stored in one of the memory units. It is presently believed that one or more embodiments will advantageously employ processing functionality within network 138

The portable device can include a body portion. For example, this could be a laminated plastic body (as discussed above) in the case of “smart” cards 102, 112, or the handset chassis and body in the case of a cellular telephone

It will be appreciated that the terminals 122, 124, 125, 126 are examples of terminal apparatuses for interacting with a payment device of a holder. The apparatus can include a processor such as processor 130, a memory such as memory 128 that is coupled to the processor, and a communications module such as 132 that is coupled to the processor and configured to interface with the portable apparatuses 102, 112, 142. The processor 130 can be operable to communicate with portable payment devices of a user via the communications module 132. The terminal apparatuses can function via hardware techniques in processor 130, or by program instructions stored in memory 128. Such logic could optionally be provided from a central location such as processing center 140 over network 138. The aforementioned bar code scanner 134 and/or RFID tag reader 136 can be provided, and can be coupled to the processor, to gather attribute data, such as a product identification, from a UPC code or RFID tag on a product to be purchased. In some environments, such as, e.g., a transit system with a fixed fare, some items, such as 134 and 136, may not be present, since, e.g., only one item can be purchased (the fixed-fare ride), or identification can occur via other means. Further, it should be noted that the description of the exemplary elements in FIG. 1 is by way of a complete description of one of many possible environments in which one or more inventive embodiments may operate, but it is not meant to imply that all instances of the invention are necessarily embodied within systems having all the depicted features.

The above-described devices 102, 112 can be ISO 7816-compliant contact cards or devices or ISO 14443-compliant proximity cards or devices. In operation, card 112 can be touched or tapped on the terminal 124 or 128, which then contactlessly transmits the electronic data to the proximity IC chip in the card 112 or other wireless device

One or more of the processing centers 140, 142, 144 can include a database such as a data warehouse 154, and/or such a warehouse could be provided within, or accessible to, network 138 or components thereof, such as platform 302 discussed below. Database 308, discussed below, could be located in a data warehouse, such as 154, accessible to platform 302.

Attention should now be given to FIG. 2, which is a flow chart 200 of exemplary method steps in accordance with an aspect of the invention. One or more of the steps can be performed to accomplish several goals. In one aspect, the method can be performed to update parameters of a payment card account in response to life changes of a holder of the payment card account. After beginning at block 202, block 204 includes obtaining access to data describing a first set of parameters associated with the payment card account. Stated another way, the data describes the “initial conditions” of the account Such initial conditions may have been established in a number of ways. For example, they may be defaults, or have been selected by an account holder when the account was established (possibly with input from a customer service representative). In some instances, the initial conditions may be set using an inventive web interface described hereinafter. The possibility of translating the initial parameters is discussed below.

The method further includes obtaining indications of a first change in a life situation of the holder, the first change occurring since establishment of the first set of parameters. Stated in another way, we wait for a while and see what happens to the account holder's payment card needs, or we find out that the person got married, had children, retired, and so on. As per decision block 206, if no indications of a change are noted (“NO” branch), operation simply continues with the initial account parameters until such a change is indicated (or until change in the parameters occurs through some other mechanism). Conversely, if a change has been indicated, as per the “YES” branch, processing proceeds to block 208. Block 208 can include facilitating presentation of a first menu of updated parameter choices to the holder, the first menu being based upon the first change in the life situation of the holder. Non-limiting examples of menus arc presented hereinafter. Stated in another way, a menu is presented based on some kind of updated life situation since the baseline was established.

Block 210 includes obtaining a holder selection from the first menu (in some instances, only if eligible, as discussed below). The holder selection from the first menu can include data describing a second set of parameters associated with the payment card account, the second set of parameters being different than the first set of parameters. That is, account holder picks different parameters than the initial conditions (of course, in some instances, an account holder might decide to retain the initial conditions). Step 212 includes facilitating updating the payment card account to operate according to the second set of parameters (that is, the card account now operates with the new parameters).

As shown at decision block 214, any or all of steps 204-212 can be repeated as appropriate for additional holders and/or additional banks or other financial institutions. Thus, in some instances, the holder is a first holder and the payment card account is a first payment card account, and an additional step is performed of repeating the described steps for a second holder of a second payment card account (in the most general case, at either the same or a different financial institution as the first payment card account). In at least some instances, in the repeated step of facilitating presentation of the first menu 208, the first menu presented to the first holder and the first menu presented to the second holder are different from each other based on different characteristics of the first holder and the second holder. That is, in some cases, we show different menus to different customers. It should be noted at this point that words such as “one,” “we,” and so on do not necessarily imply human agency, but are intended generally to also encompass actions performed in whole or in part by automated techniques.

Still referring to decision block 214, if there are not more holders and/or more banks, as per the “NO” branch, processing flows back to block 206, to detect any additional changes that may occur with the given holder, while in the case of the “YES” branch, processing flows all the way back to step 204. Thus, in some instances, as per the “NO” branch of block 214, an additional step includes obtaining indications of a second change in the life situation of the given holder, the second change occurring since establishment of the second set of parameters. Stated in another way, we wait for another time period, after the first access to the inventive menu. The repetition of block 208 can include facilitating presentation of a second menu of updated parameter choices to the holder, the second menu being based upon the second change in the life situation of the holder (in other words, as discussed below, we present another updated menu, for example, after 6 months or one year after the first time the update menu is presented, or when the person logs on to the web site—thus the amount of time that we wait can be a predefined time, or can be based on detection of some kind of life change (for example, surmised because of changes in the account holder's habits), or can be responsive to pro-active actions by the account holder, such as logging in to select new parameters).

In this particular instance, the repetition of block 210 includes obtaining a holder selection from the second menu, the holder selection from the second menu including data describing a third set of parameters associated with the given holder's payment card account. The third set of parameters can be different than the second set of parameters, and the second menu can be different than the first menu. Essentially, the account holder picks new parameters from a new menu that can be different than the first menu he or she saw, with changes in the menu based on further life changes of the account holder. The repetition of step 212 can include facilitating updating the payment card account to operate according to the third set of parameters. Again, new parameters need not be selected in every case; the card holder can always decide to retain the old parameters if he or she wishes to do so.

As with the indications of the first change, the indications of the second change in the life situation of the holder can be based, for example, upon passage of a predetermined time since the first change in the life situation of the holder. That is, we might prompt the account holder to update after a predetermined time period, such as six months or a year. In another approach, the indications of the first change in the life situation of the holder are obtained from the holder. That is, the holder decides when he or she wants to update the account parameters. In yet another approach, the indications of the first change in the life situation of the holder involve a predictive model that predicts and/or detects life changes based on spending (for example, a consumer's transaction history) or other parameters (for example, risk profile, how long a person has been a member), and that can additionally or alternatively suggest appropriate menus of parameters based on the changes (or perform some subset of the indicated functionality).

Turning back momentarily to block 210 (in particular, the obtaining of a selection if eligible), in some instances, an additional step includes facilitating advising the holder that the holder is not eligible to make selections from the first menu, for example, prior to elapse of a predetermined time after establishment of the initial parameters (or since the last update). The steps of facilitating presentation of the first menu and obtaining the holder selection from the first menu can be permitted subsequent to the elapse of the predetermined time. That is, the holder decides when he or she wants to update the parameters, but this is only allowed after a certain time passes (say once every six months or one year).

With regard to block 208, in some instances, the step of facilitating the presentation of the first menu can include running at least one predictive model to determine candidate payment card account parameters likely to be desired by the holder, based on the first change in the life situation of the holder. The predictive model may, for example, take into account the first set of parameters and spending behavior of the holder of the payment card account (the operator of network 138, such as MasterCard International Incorporated, may typically have such information available). In one or more embodiments, the predictive model may take into account age of the holder, employment status of the holder, student status of the holder, home ownership status of the holder, whether the holder is a parent of a minor child, and a financial risk profile of the holder of the payment card account (a financial institution, such as a bank (perhaps an issuer operating one of the processing centers 140, 142, 144), may typically have such information available). In some instances, the step of facilitating the presentation of the first menu further includes running at least one risk model on the holder. Of course, in any case, all information should only be obtained and used in compliance with applicable privacy rules and regulations, and the like. Predictive modeling can be done, for example, using pattern recognition and/or data mining techniques. In some instances, techniques disclosed in U.S. Provisional Patent Application Ser. No. 60/894,908 of inventors Louis Mello, Dan Salazar, Anant Nambiar, and Marc Del Bene, filed on Mar. 14, 2007 and entitled “Method and System for Predicting Consumer Needs or Behavior from Consumer Data” can be employed. The complete disclosure of the aforesaid U.S. Provisional Patent Application Ser. No. 60/894,908 is expressly incorporated herein by reference for all purposes.

One or more exemplary embodiments are discussed within the context of a credit card account; however, it will be appreciated that inventive techniques are generally applicable to payment card accounts, including credit, debit, and pre-paid card accounts. The parameters of the payment card account can include, for example, one or more of (as appropriate to the particular kind of card) interest rate, reward structure, fee structure, spending control rules, and benefits, and so on. Benefits can include, for example, one or more of travel, insurance, medical, and the like.

Still with reference to FIG. 2, recall that the method can be performed for several purposes; in another aspect, an exemplary method is provided for updating parameters of payment card accounts across banks or other financial institutions. After beginning at block 202, as pet block 204, one step includes obtaining access to (i) data describing a first set of parameters associated with a first one of the payment card accounts, of a first holder, at a first one of the financial institutions, and (ii) data describing a second set of parameters associated with a second one of the payment card accounts, of a second holder, at a second one of the financial institutions (as per the loop from decision block 214 for the second bank). Another step includes facilitating presentation of a first menu of parameter update choices to the first holder and a second menu of parameter update choices to the second holder, as per block 208, again with the loop from decision block 214 Yet another step includes obtaining a first holder selection from the first menu and a second holder selection from the second menu, as at block 210, once again with looping from decision block 214. The first holder selection from the first menu includes data describing a third set of parameters associated with the first payment card account, the third set of parameters being different than the first set of parameters, and the second holder selection from the second menu includes data describing a fourth set of parameters associated with the second payment card account, the fourth set of parameters being different than the second set of parameters. Yet another step includes facilitating updating the first and second payment card accounts to operate according to the third and fourth sets of parameters, respectively, as at block 212, still again within the loop from block 214. The steps are advantageously performed by a service provider, such as an operator of payment card network 138.

Stated in another way, the method described in the previous paragraph can be performed by a service provider for multiple (issuing) banks (or other financial institutions) (most likely having different cardholders but some individuals may be cardholders of accounts at more than one of the banks). In essence, this aspect of the invention provides an infrastructure that allows any bank to offer the account personalization service—the “rails” that enable the service. Thus, in this aspect, steps 204, 208, 210, and 212 can be performed across financial institutions, by a service provider, without necessarily requiring the menu presented to each individual to be customized based on life changes (although this can be done if desired). The service can be provided for banks that process transactions themselves, and/or for banks that leverage processors who perform actual processing services for them. In some instances, as mentioned at block 204, the service provider can be equipped to translate account parameter data from a number of different banks, institutions or systems.

In view of the foregoing description, it will be appreciated that in one or more embodiments, inventive account personalization techniques may allow consumers of any participating bank to access a website (or other consumer interface) and personalize their credit cards without the need to reapply for a new card or change their account numbers. For example, one or more embodiments may allow one or more of the following:
Allows for the customization of a variety of card parameters which may include, by way of example and not limitation, fees, interest rate, rewards (potentially including a choice of merchant categories where consumers would earn mole rewards), features and benefits, spend controls (e.g. spend limits or blocks on select merchant categories), card design, and/or other card options
Can offer consumers tailored options based, for example, on their previous card selections, their credit card spending behavior and/or their financial/risk profile. The account personalization capability may be linked to one or more predictive models that will anticipate card parameters that consumers are most likely to want. In other words, in one or more embodiments, the options presented to consumers are dynamic and will vary from per son to person.
Can be used across financial institutions—need not be confined to customers of one specific bank. One or more embodiments of the invention offer a front end consumer interface that can be used across banks. In addition, a back-end solution that enables consumers' choices can be configured to communicate with most banks, regardless of their processing relationships with third party service providers.

With reference now to FIG. 3, an exemplary embodiment of an inventive system 300 can include a consumer-facing front end (discussed further below), and a back-end solution, for example, in the form of account personalization platform 302, that connects all involved parties (for example, issuer 304 and consumer 306), provides secure data transfer, and enables the functionality described herein. The platform 302 can inform what card parameters and choices to make available to each consumer 306; for example, a back end intelligent processing system can suggest what card options should be made available to each consumer 306. This system may include bank-defined rules and/or data models, such as those in database 308, that interpret consumer data in older to inform the card choices that are most relevant to each consumer. Platform 302 may also enable the appropriate packaging and routing of information between all involved parties (e.g. issuers 304, processors, the operator of a payment card network such as MasterCard International Incorporated, third party service providers, and so on) in a secure and reliable manner. This back end solution may or may not displace or overlap any existing systems within existing infrastructure 100.

Still with reference to FIG. 3, bank ox card issuer 304 may provide (to platform 302) current account information, including current annual percentage rate (APR), fees, card benefits and features, and so on, as depicted at data flow arrow 310. Card parameters and/or options that the consumer can select from can be customized based on, for example, issuer-specific set-up rules (such as proprietary risk models), as well as predictive models that use consumer behavior to predict most relevant options, as indicated by the arrow from database 308 to platform 302. Options available to the consumer can be uploaded (for example, from 302) to a consumer interlace, such as that which will be described below. These options may be updated as the consumer's profile changes (for example, the consumer's spending behavior indicates that additional card benefits may be relevant, the consumer's financial situation changes, and so on). The consumer 306 accesses the system (via web site or other consumer interface as discussed below), views available card options, and updates his or her card by selecting desired options. Requested changes (such as, for example, to one or more of rewards 312, benefits 314, and other parameters 316) are communicated to appropriate parties and changes are made to the account. Confirmation of changes can be communicated back to the card issuer 304, as per data flow arrow 318.

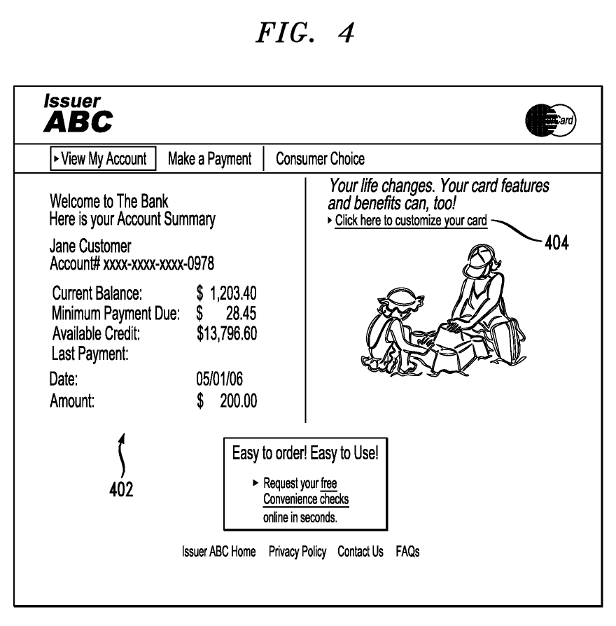

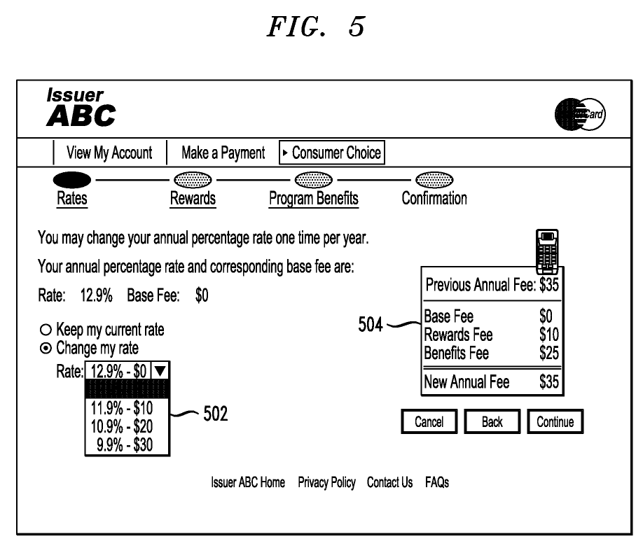

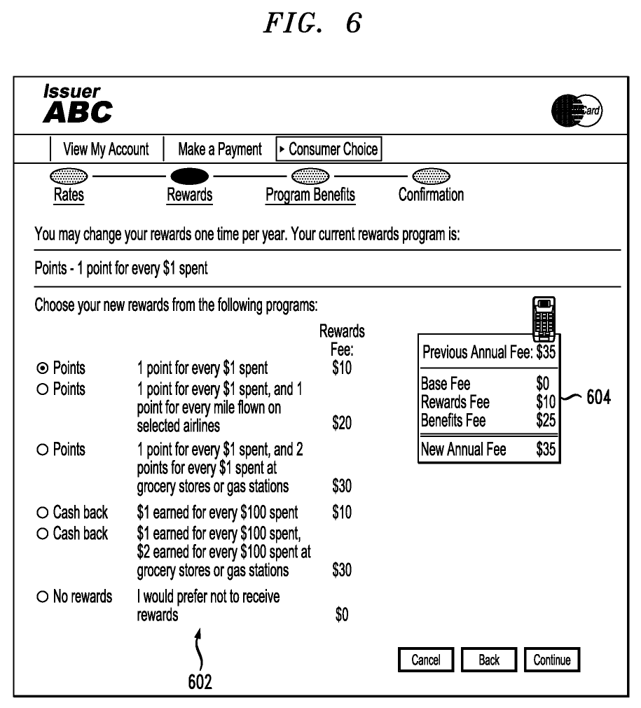

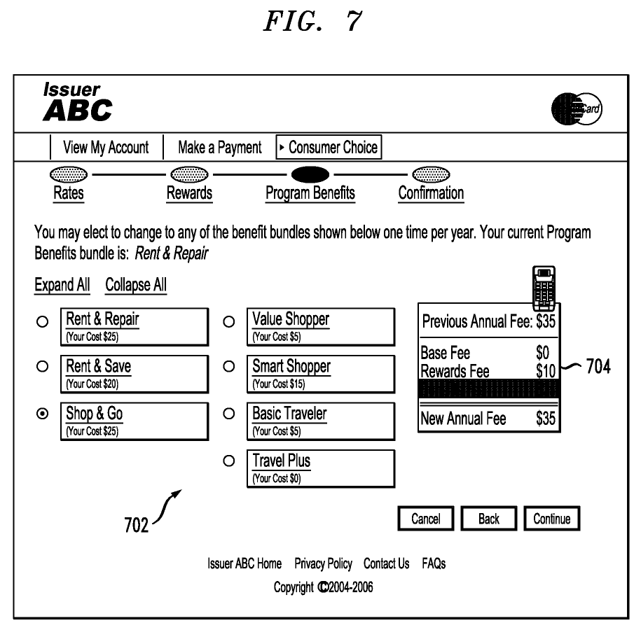

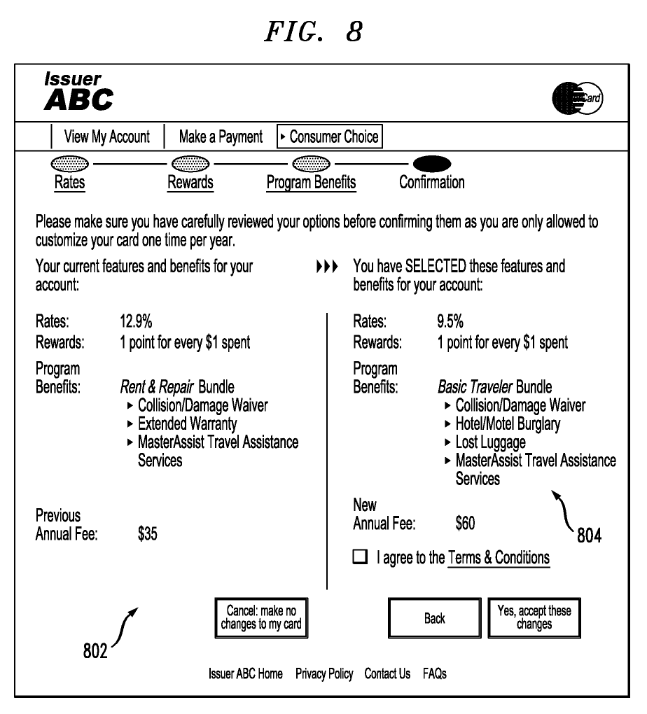

Giving attention now to FIGS. 4-9, the front end consumer interface can allow consumers to view a set of card options or parameters and communicate the new card parameters that they would like applied to their credit cards. The interface can be, for example, a website, though it could also be in another form, such as an ATM terminal. The card options available to consumers may be customized based on each consumer's specific profile, which may include: card transaction behavior, previous card option selections, the particular consumer's financial situation, and/or risk profile. FIG. 4 shows an exemplary interface wherein the user is presented with some current account information 402 and a link 404 to an interface for card customization. FIG. 5 shows an exemplary interface for changing the annual percentage rate 502 with corresponding annual fees 504. FIG. 6 shows an exemplar interface for changing the rewards 602 with corresponding annual fees 604. FIG. 7 shows an exemplary interface for changing the benefits 702 with corresponding annual fees 704. FIG. 8 shows an exemplary screen where an account holder can view his or her current features and benefits 802 and compare them to newly selected features and benefits 804, prior to confirming that the changes should take place.

In one or more inventive embodiments, features and benefits available to consumers are not static. Different consumers may have different options to select from, depending on their profile, their past card usage and/or past feature and benefit selections. In addition, one or more inventive embodiments are not confined to customers of one specific bank. The consumer interface and back end solution can be adopted by any bank wishing to offer inventive services to its customers. By way of review, it should be noted that consumers can use one or more embodiments of the invention to update the parameters of their cards whether or not they actually experience a life-changing event; they may simply have a change in preference and opt to modify their card parameters. The options presented to each consumer may be informed by predicted life events (indicated, for example, by the consumer's transaction behavior), but may also be informed by specific purchases the consumer made using his or her card, consumers' previous selections of features and benefits, and/or a change in a given consumer's risk profile. One or more embodiments of the invention can be offered to existing cardholders for whom an entity, such as a service provider, already has all the necessary transaction data to craft a relevant set of card features and benefits for the cardholders to choose from. In other words, one or more embodiments of the invention can be used to improve existing cardholders' loyalty and/or satisfaction, as well as to attract new cardholders.

Thus, holders may be presented with an update menu in response to predicted life changes. In another aspect, holders are presented with a customized menu, but not necessarily based on a predicted life change; possibly simply based on their own initiative. The two approaches may be combined, such that holders may be presented with a customized menu in response to predicted life changes, and the menu may be customized, for example, based upon the predicted life changes.

It will therefor be appreciated that an exemplary method (which can be computer-implemented) of updating parameters of a payment card account having a holder, includes the step of obtaining access to data describing a first set of parameters associated with the payment card account, as at block 204 in FIG. 2. The method further includes the step of facilitating presentation of a first menu of updated parameter choices to the holder, as at block 208 in FIG. 2. The first menu is customized for the holder, but in this aspect, its presentation need not necessarily be responsive to a predicted life change as at block 206. The method further includes obtaining a holder selection from the first menu, as at block 210. The holder selection from the first menu includes data describing a second set of parameters associated with the payment card account, the second set of parameters being different than the first set of parameters. The method further includes facilitating updating the payment card account to operate according to the second set of parameters, as at block 212.

The first menu can be customized (in whole or in part) based upon a number of factors, for example: (i) at least one predicted life event of the holder (the predicted life event can be predicted, at least in part, based on transaction behavior of the holder); (ii) specific purchases made by the holder; (iii) previous selections of card-related features and benefits by the holder (from an inventive menu or otherwise); and/or (iv) a change in risk profile of the holder.

U.S. patent application Ser. No. 11/640,747, filed Dec. 18, 2006, discloses a Method and Apparatus for Transaction Management. U.S. Provisional Patent Application Ser. No. 60/828,202, of inventors Myers, Burbridge, and Ameiss, filed Oct. 4, 2006, discloses a Method and System for Managing a Non-Changing Payment Card Account Number. The complete disclosures of both the aforesaid U.S. patent application Ser. No. 11/640,747 and the aforesaid U.S. Provisional Patent Application Ser. No. 60/828,202 are expressly incorporated herein by reference for all purposes. In one or more embodiments, the spending control techniques of the Ser. No. 11/640,747 application, and/or the techniques of the 60/828,202 application, which permit maintaining a single account number despite parameter changes made to an account, may advantageously be combined with the inventive techniques set forth herein.

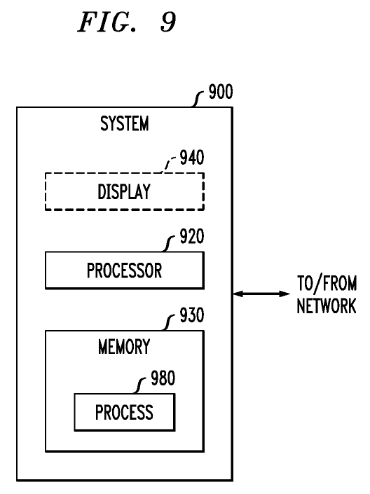

The invention can employ hardware and/or software aspects. Software includes but is not limited to firmware, resident software, microcode, etc. Software might be employed, for example, in connection with one or more of a terminal 122, 124, 125, 126, a processing center 140, 142, 144 (optionally with data warehouse 154) of a merchant, issuer, acquirer, processor, or payment processing network operator, and/or platform 302. Firmware might be employed, for example, in connection with payment devices such as cards 102, 112. FIG. 9 is a block diagram of a system 900 that can implement part or all of one or more aspects or processes of the present invention. As shown in FIG. 9, memory 930 configures the processor 920 (which could correspond, e.g., to processor portions 106, 116, 130, a processor of element 302, or processors of remote hosts in centers 140, 142, 144) to implement one or more aspects of the methods, steps, and functions disclosed herein (collectively, shown as process 980 in FIG. 9). Different method steps can be performed by different processors. The memory 930 could be distributed or local and the processor 920 could be distributed or singular. The memory 930 could be implemented as an electrical, magnetic or optical memory, or any combination of these or other types of storage devices (including memory portions as described above with respect to cards 102, 112). Persistent storage can also be provided by, for example, data warehouse 154 and database 308. It should be noted that if distributed processors are employed, each distributed processor that makes up processor 920 generally contains its own addressable memory space. It should also be noted that some or all of computer system 900 can be incorporated into an application-specific or general-use integrated circuit. For example, one or more method steps could be implemented in hardware in an ASIC rather than using firmware. Display 940 is representative of a variety of possible input/output devices.

### System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, EEPROMs, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks) For example, one device could be a physical memory media associated with a terminal and another device could be a physical memory media associated with a processing center.

The computer systems and servers described herein each contain a memory that will configure associated processors to implement the methods, steps, and functions disclosed herein. Such methods, steps, and functions can be carried out, e.g., by processing capability on elements 106, 116, 130, a processor of element 302, or processors of remote hosts in centers 140, 142, 144, or by any combination of the foregoing. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned processors 106, 116, 130, a processor of element 302, or processors of remote hosts in centers 140, 142, 144, can make use of computer technology with appropriate instructions to implement method steps described herein. By way of further example, a terminal apparatus 122, 124, 125, 126 could include, inter alia, a communications module, an antenna coupled to the communications module, a memory, and at least one processor coupled to the memory and the communications module and operative to interrogate a contactless payment device (in lieu of the antenna and communications module, appropriate contacts and other elements could be provided to interrogate a contact payment device such as a contact card or read a magnetic stripe) In general terms, the processor(s) can be operative to perform one or more method steps described herein, or otherwise facilitate their performance.

Accordingly, it will be appreciated that one or more embodiments of the present invention can include a computer program comprising computer program code means adapted to perform one or all of the steps of any methods or claims set forth herein when such program is run on a computer, and that such program may be embodied on a computer readable medium. Further, one or more embodiments of the present invention can include a computer comprising code adapted to cause the computer to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method of updating parameters of a payment card account in response to life changes of a holder of said payment card account, said method comprising the steps of:
obtaining access to data describing a first set of parameters associated with said payment card account;
obtaining indications of a first change in a life situation of said holder, said first change occurring since establishment of said first set of parameters;
facilitating presentation of a first menu of updated parameter choices to said holder, said presentation of said first menu being based upon said first change in said life situation of said holder;
obtaining a holder selection from said first menu, said holder selection from said first menu comprising data describing a second set of parameters associated with said payment card account, said second set of parameters being different than said first set of parameters; and
facilitating updating said payment card account to operate according to said second set of parameters.

2. The method of claim 1, wherein said holder is a first holder and said payment card account is a first payment card account, further comprising the additional step of repeating said steps for a second holder of a second payment card account, wherein, in said repeated step of facilitating presentation of said first menu, said first menu presented to said first holder and said first menu presented to said second holder are different from each other based on different characteristics of said first holder and said second holder.

3. The method of claim 2, further comprising the additional steps of:
obtaining indications of a second change in said life situation of said holder, said second change occurring since establishment of said second set of parameters;
facilitating presentation of a second menu of updated parameter choices to said holder, said presentation of said second menu being based upon said second change in said life situation of said holder;
obtaining a holder selection from said second menu, said holder selection from said second menu comprising data describing a third set of parameters associated with said payment card account, said third set of parameters being different than said second set of parameters, said second menu being different than said first menu; and
facilitating updating said payment card account to operate according to said third set of parameters.

4. The method of claim 3, wherein said indications of said second change in said life situation of said holder are based upon passage of a predetermined time since said first change in said life situation of said holder.

5. The method of claim 2, wherein said indications of said first change in said life situation of said holder are obtained from said holder.

6. The method of claim 5, further comprising the additional step of facilitating advising said holder that said holder is not eligible to make selections from said first menu, prior to elapse of a predetermined time after establishment of said initial parameters, wherein said steps of facilitating presentation of said first menu and obtaining said holder selection from said first menu are permitted subsequent to said elapse of said predetermined time.

7. The method of claim 2, wherein said step of facilitating said presentation of said first menu comprises running at least one predictive model to determine candidate payment card account parameters likely to be desired by said holder, based on said first change in said life situation of said holder.

8. The method of claim 7, wherein said predictive model takes into account said first set of parameters and spending behavior of said holder of said payment card account.

9. The method of claim 8, wherein said predictive model further takes into account age of said holder, employment status of said holder, student status of said holder, home ownership status of said holder, whether said holder is a parent of a minor child, and a financial risk profile of said holder of said payment card account.

10. The method of claim 7, wherein said step of facilitating said presentation of said first menu further comprises running at least one risk model on said holder.

11. The method of claim 2, wherein said payment card account comprises a credit card account.

12. The method of claim 2, wherein said payment card account comprises a debit card account.

13. The method of claim 2, wherein said payment card account comprises a pre-paid card account.

14. The method of claim 2, wherein said parameters of said payment card account comprise interest rate, reward structure, fee structure, spending control rules, and benefits.

15. The method of claim 2, wherein:
said holder is a first holder;
said payment card account is a first payment card account at a first bank; and
said steps are performed by a service provider;
further comprising the additional step of repeating said steps, by said service providers for a second holder of a second payment card account at a second bank.

16. A method of updating parameters of payment card accounts across financial institutions, said method comprising the steps of:
obtaining access to (i) data describing a first set of parameters associated with a first one of said payment card accounts, of a first holder, at a first one of said financial institutions, and (ii) data describing a second set of parameters associated with a second one of said payment card accounts, of a second holder, at a second one of said financial institutions;
facilitating presentation of a first menu of parameter update choices to said first holder and a second menu of parameter update choices to said second holder;
obtaining a first holder selection from said first menu and a second holder selection from said second menu, said first holder selection from said first menu comprising data describing a third set of parameters associated with said first payment card account, said third set of parameters being different than said first set of parameters, said second holder selection from said second menu comprising data describing a fourth set of parameters associated with said second payment card account, said fourth set of parameters being different than said second set of parameters; and
facilitating updating said first and second payment card accounts to operate according to said third and fourth sets of parameters, respectively;
wherein said steps are performed by a service provider.

17. A system for updating parameters of a payment card account in response to life changes of a holder of said payment card account, said system comprising:
means for obtaining access to data describing a first set of parameters associated with said payment card account;
means for obtaining indications of a first change in a life situation of said holder, said first change occurring since establishment of said first set of parameters;
means for facilitating presentation of a first menu of updated parameter choices to said holder, said presentation of said first menu being based upon said first change in said life situation of said holder;
means for obtaining a holder selection from said first menu, said holder selection from said first menu comprising data describing a second set of parameters associated with said payment card account, said second set of parameters being different than said first set of parameters; and
means for facilitating updating said payment card account to operate according to said second set of parameters

18. The system of claim 17, wherein said holder is a first holder and said payment card account is a first payment card account, further comprising means for repeating said obtaining access, obtaining indications, facilitating presentation, selection obtaining, and facilitating updating for a second holder of a second payment card account, wherein said means for facilitating presentation of said first menu comprise means for presenting different first menus to said first and second holders based on different characteristics of said first holder and said second holder.

19. An apparatus for updating parameters of a payment card account in response to life changes of a holder of said payment card account, said apparatus comprising:
a memory; and
at least one processor coupled to said memory, said processor being operative to:
obtain access to data describing a first set of parameters associated with said payment card account;
obtain indications of a first change in a life situation of said holder, said first change occurring since establishment of said first set of parameters;
facilitate presentation of a first menu of updated parameter choices to said holder, said presentation of said first menu being based upon said first change in said life situation of said holder;
obtain a holder selection from said first menu, said holder selection from said first menu comprising data describing a second set of parameters associated with said payment card account, said second set of parameters being different than said first set of parameters; and
facilitate updating said payment card account to operate according to said second set of parameters.

20. The apparatus of claim 19, wherein:
said holder is a first holder and said payment card account is a first payment card account;
said processor is further operative to repeat said obtaining access, obtaining indications, facilitating presentation, selection obtaining, and facilitating updating for a second holder of a second payment card account, and to present different first menus to said first and second holders based on different characteristics of said first holder and said second holder.

21. A method of updating parameters of a payment card account having a holder, said method comprising the steps of:
obtaining access to data describing a first set of parameters associated with said payment card account
facilitating presentation of a first menu of updated parameter choices to said holder, said first menu being customized for said holder;
obtaining a holder selection from said first menu, said holder selection from said first menu comprising data describing a second set of parameters associated with said payment card account, said second set of parameters being different than said first set of parameters; and
facilitating updating said payment card account to operate according to said second set of parameters.

22. The method of claim 21, wherein said first menu is customized based, at least in part, on at least one predicted life event of said holder; said predicted life event being predicted, at least in part, based on transaction behavior of said holder.

23. The method of claim 21, wherein said first menu is customized based, at least in part, on specific purchases made by said holder.

24. The method of claim 21, wherein said first menu is customized based, at least in part, on previous selections of card-related features and benefits by said holder.

25. The method of claim 21, wherein said first menu is customized based, at least in part, on a change in risk profile of said holder.
